(19) United States
(12) Patent Application Publication
(10) Pub. No.: US 2011/0201291 A1
(43) Pub. Date: Aug. 18, 2011

(54) MOBILE STATION AND MOBILE COMMUNICATION METHOD

(75) Inventors: Mototsugu Suzuki, Kanagawa (JP); Tetsurou Imai, Kanagawa (JP); Koushirou Kitao, Kanagawa (JP); Yoshihiro Ishikawa, Kanagawa (JP)

(73) Assignee: NTT DOCOMO, INC., Tokyo (JP)

(21) Appl. No.: 13/060,961

(22) PCT Filed: Aug. 27, 2009
(86) PCT No.: PCT/JP2009/064924

§ 371 Date: May 4, 2011

(30) Foreign Application Priority Data
Aug. 27, 2008 (JP) 2008-218512

(51) Int. Cl. H04W 24/08

(52) U.S. Cl. 455/226.2

(57) ABSTRACT

A mobile station UE includes: a measuring unit (12) which measures the reception power of a predetermined signal formed by symbols continuously transmitted in the frequency axis direction or the time axis direction; an estimating unit (14) which estimates the propagation loss of a predetermined signal in the downlink in accordance with the transmission power of a predetermined signal stored in advance and the reception power of the predetermined signal measured by the measuring unit (12); and a calculating unit which calculates the reception power of a pilot signal in accordance with the transmission power of the pilot signal stored in advance and the propagation loss of the predetermined signal estimated by the estimating unit (14).

### TECHNICAL FIELD

The present invention relates to a mobile station and a mobile communication method.

### BACKGROUND ART

In a W-CDMA (Wideband-Code Division Multiple Access) mobile communication system, a receiving apparatus (for example, a mobile station) is configured to measure the reception power of pilot symbols contained in a CPICH (Common Pilot Channel) signal transmitted by a radio base station in order to calculate the radio quality in the downlink.

The W-CDMA mobile communication system is configured such that multiple pilot symbols are transmitted continuously in the time axis direction at the same frequency.

### SUMMARY OF THE INVENTION

### Problem to be Solved by the Invention

On the other hand, an LTE (Long Term Evolution) mobile communication system is configured such that multiple pilot symbols are transmitted discontinuously in the frequency axis direction and the time axis direction within a predetermined system band and at predetermined timings.

Therefore, in the LTE mobile communication system, fading effects on the respective pilot symbols highly possibly differ (that is, frequency correlation and time correlation between the pilot symbols are possibly low). For this reason, the LTE mobile communication system has a problem in that the mobile station is unable to accurately measure the average reception quality of multiple pilot symbols (for example, an average value of the reception powers, and the like) when employing the same calculation method as that employed in the W-CDMA mobile communication system.

In this respect, the present invention has been made in view of the above-mentioned problem. It is an objective of the present invention to provide a mobile station and a mobile communication method which are capable of accurately measuring the average reception quality (for example, an average value of the reception powers, and the like) of multiple pilot symbols transmitted discontinuously in the frequency axis direction and the time axis direction.

### Means for Solving the Problems

A first feature of the present invention is summarized as a mobile station including: a measuring unit configured to measure a reception power of a predetermined signal constituted of a symbol transmitted continuously in a frequency axis direction or in a time axis direction; an estimating unit configured to estimate a propagation loss of the predetermined signal in a downlink on the basis of a transmission power of the predetermined signal and the reception power of the predetermined signal measured by the measuring unit, the transmission power of the predetermined signal being stored in advance; and a calculating unit configured to calculate a reception power of a pilot signal on the basis of a transmission power of the pilot signal and the propagation loss of the predetermined signal estimated by the estimating unit, the transmission power of the pilot signal being stored in advance.

In the first feature of the present invention, the measuring unit is configured to measure the reception power of the predetermined signal by performing an averaging process on reception powers of a plurality of the symbols transmitted continuously in the frequency axis direction or in the time axis direction.

A second feature of the present invention is summarized as a mobile communication method including the steps of: measuring, at a reception apparatus, a reception power of a predetermined signal constituted of a symbol transmitted continuously in a frequency axis direction or in a time axis direction; estimating, at the reception apparatus, a propagation loss of the predetermined signal in a downlink on the basis of a transmission power of the predetermined signal and the reception power of the predetermined signal thus measured, the transmission power of the predetermined signal being stored in advance; and calculating a reception power of a pilot signal on the basis of a transmission power of the pilot signal and the propagation loss of the predetermined signal thus estimated, the transmission power of the pilot signal being stored in advance.

### Effects of the Invention

As described above, the present invention provides a mobile station and a mobile communication method which are capable of accurately measuring the average reception quality (for example, an average value of reception powers, and the like) of multiple pilot symbols discontinuously transmitted in the frequency axis direction and the time axis direction.

### BRIEF DESCRIPTION OF THE DRAWINGS

FIG. 1 is an overall configuration diagram of a mobile communication system according to a first embodiment of the present invention.

FIG. 2 is a diagram for explaining a signal transmitted with a predetermined bandwidth in a mobile communication system according to the first embodiment of the present invention.

FIG. 3 is a functional block diagram of a mobile station according to the first embodiment of the present invention.

FIG. 4 is a flowchart showing operation of a radio base station according to the first embodiment of the present invention.

### EMBODIMENTS FOR CARRYING OUT THE INVENTION

### Configuration of a Mobile Communication System According to a First Embodiment of the Present Invention

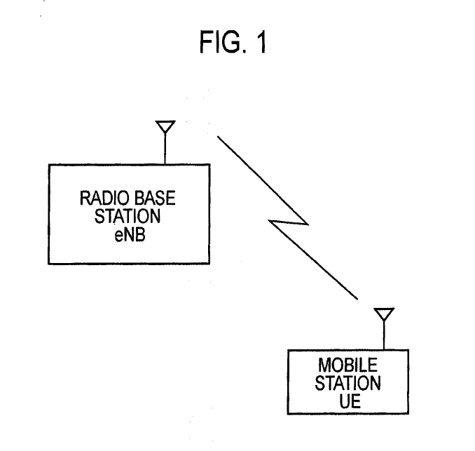

A configuration of a mobile communication system according to a first embodiment of the present invention is described with reference to FIG. 1 to FIG. 3.

As shown in FIG. 1, the mobile communication system according to the present embodiment is a LTE mobile communication system and includes a radio base station eNB and a mobile station UE.

The radio base station eNB is configured to transmit a P-BCH (Physical-Broadcast Channel) signal, a P-SCH (Primary-Synchronization Channel) signal, an S-SCH (Secondary-Synchronization Channel) signal, a reference signal (RS), and the like, as physical channel signals in the downlink.

The P-BCH signal is a broadcast signal transmitted once every 10 ms, to which a time diversity of transmitting the same information while changing a scramble code over four consecutive radio frame sections is employed in order to secure the coverage.

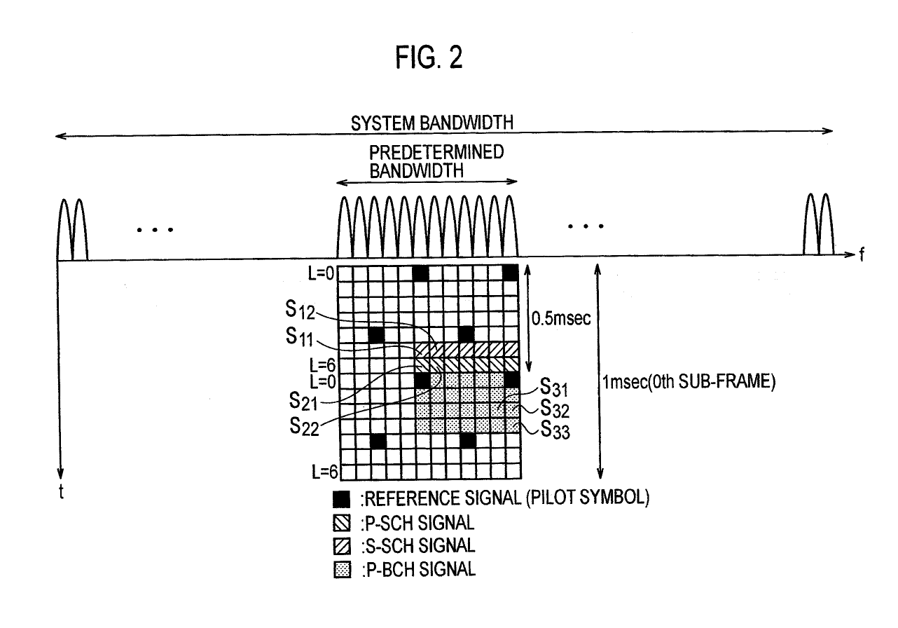

As shown in FIG. 2, the P-BCH signal is constituted of symbols continuously transmitted in the frequency axis direction and the time axis direction in a subframe #0 within a predetermined frequency band (a central frequency band in the mobile communication system).

Further, the P-SCH signal and the S-SCH signal are synchronization signals used in the cell searching process performed by the mobile station UE. As shown in FIG. 2, the P-SCH signal is constituted of symbols continuously transmitted in the frequency axis direction in the subframe #0 within a predetermined frequency band.

Further, the reference signal is a pilot signal used in the channel estimation process and the channel quality measurement process performed by the mobile station UE. As shown in FIG. 2, the reference signal is constituted of symbols discontinuously transmitted in the frequency axis direction or the time axis direction in the subframe #0 within a predetermined frequency band.

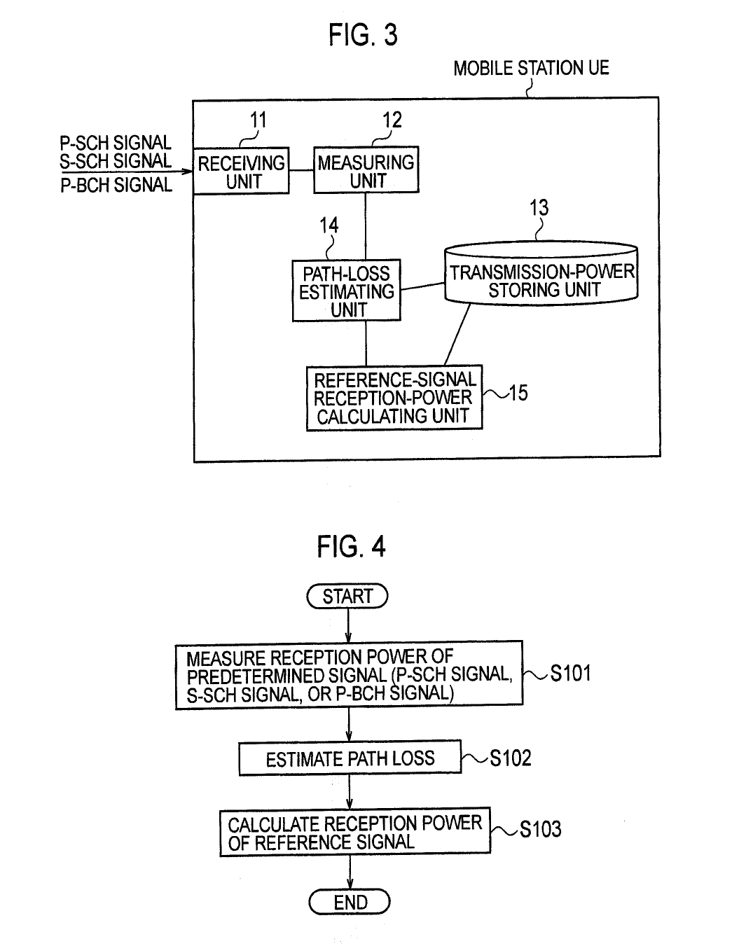

As shown in FIG. 3, the mobile station UE includes a receiving unit 11, a measuring unit 12, a transmission-power storing unit 13, a path-loss estimating unit 14, and a reference-signal reception-power calculating unit 15.

The receiving unit 11 is configured to receive the P-SCH signal, the S-SCH signal, the P-BCH signal, the reference signal, and the like transmitted by the radio base station eNB.

The measuring unit 12 is configured to measure the reception power of a predetermined signal constituted of symbols continuously transmitted in the frequency axis direction or the time axis direction. For example, the measuring unit 12 is configured to measure the reception power of the P-SCH signal, the S-SCH signal or the P-BCH signal, as the predetermined signal.

For example, since the P-SCH signal is constituted of symbols continuously transmitted in the frequency axis direction, the measuring unit 12 may be configured to measure the reception power of the P-SCH signal by performing an averaging process on the reception powers of multiple symbols constituting the P-SCH signal according to (Formula 1) shown below on the assumption that the correlation among the multiple symbols is high.

$$\begin{matrix}[ Formula 1 ] & \\ {λ}_{1} = 1 / 2 {N}_{s} \times {\sum }_{1}^{{N}_{s} - 1} {\vert {r}_{n} + {r}_{n + 1} \vert}^{2} \\ {λ}_{2} = 1 / 2 {N}_{s} \times {\sum }_{1}^{{N}_{s} - 1} {\vert {r}_{n} - {r}_{n + 1} \vert}^{2} \\ RSRP = 1 / 2 \times {\vert {λ}_{1} - {λ}_{2} \vert}^{2} & ( Formula 1 )\end{matrix}$$

Here, “rn” and “rn+1” in (Formula 1) represent reception signal vectors of two symbols which constitute the P-SCH signal and are adjacent to each other in the frequency axis direction (for example, “S21” and “S22” in FIG. 2).

Note that the measuring unit 12 may be configured to measure desired-wave reception power of the P-SCH signal by performing the above-described averaging process on power values of two or more symbols which constitute the P-SCH signal and are adjacent to each other in the frequency axis direction.

Moreover, since the S-SCH signal is constituted of symbols continuously transmitted in the frequency axis direction, the measuring unit 12 may be configured to measure the reception power of the S-SCH signal by performing the averaging process on desired wave powers and interference wave powers of multiple symbols constituting the S-SCH signal according to the above-described (Formula 1) on assumption that the correlation among the multiple symbols is high.

Here, “rn” and “rn+1” in (Formula 1) represent reception signal vectors of two symbols which constitute the S-SCH signal and are adjacent to each other in the frequency axis direction constituting (for example, “S11” and “S12” in FIG. 2).

Further, the measuring unit 12 may be configured to measure desired-wave reception power of the S-SCH signal by performing the above-described averaging process on power values of two or more symbols which constitute the S-SCH signal and are adjacent to each other in the frequency axis direction.

Further, since the P-BCH signal is constituted of symbols continuously transmitted in the frequency axis direction and time axis direction, the measuring unit 12 may be configured to measure the reception power of the P-BCH signal by performing the averaging process on desired wave powers and interference wave powers of multiple symbols constituting the P-BCH signal according to the above-described (Formula 1) on assumption that the correlation among the multiple symbols is high.

Here, “rn” and “rn+1” in (Formula 1) represent reception signal vectors of two symbols which constitute the P-BCH signal and are adjacent to each other in the frequency axis direction (for example, “S31” and “S32” in FIG. 2), or reception signal vectors of two symbols which constitute the P-BCH signal and are adjacent in the time axis direction (for example, “S32” and “S33” in FIG. 2).

Note that the measuring unit 12 may be configured to measure the reception power of the P-BCH signal by performing the above-described averaging process on reception signal vectors of two or more symbols which constitute the P-BCH signal and are adjacent to each other in the frequency axis direction, reception signal vectors of two or more symbols which constitute the P-BCH signal and are adjacent to each other in the time axis direction, or combination of reception signal vectors of one or more symbols which constitute the P-BCH signal and are adjacent to each other in the frequency axis direction and reception signal vectors of one or more symbols which constitute the P-BCH signal and are adjacent to each other in the time axis direction.

It should be noted that the reception power of the P-BCH signal is calculated using a reception signal multiplied by once demodulated signal in order to match the phase of all signals.

The transmission-power storing unit 13 is configured to store the transmission power of a predetermined signal (for example, P-SCH signal, S-SCH signal or P-BCH signal). In addition, the transmission-power storing unit 13 is configured to store the transmission power of the reference signal.

Note that the transmission-power storing unit 13 may be configured to store the transmission power of each of the symbols constituting the P-SCH signal, the S-SCH signal, the P-BCH signal, or the reference signal.

The path-loss estimating unit 14 is configured to estimate the propagation loss (path loss) of a predetermined signal (for example, P-SCH signal, S-SCH signal or P-BCH signal) in the downlink on the basis of the transmission power of the predetermined signal stored in the transmission-power storing unit 13 in advance and the reception power of the predetermined signal measured by the measuring unit 12.

Here, when the transmission power of the predetermined signal (for example, P-SCH signal, S-SCH signal or P-BCH signal) is represented by “X (dBm)”, the measured reception power of the predetermined signal is represented by “Y (dBm)” and the transmission power of the reference signal is represented by “Z (dBm)”, the path-loss estimating unit 14 is configured to estimate the propagation loss of the predetermined signal in the downlink according to “X (dBm)−Y (dBm)”.

Alternatively, the path-loss estimating unit 14 may calculate the propagation loss of the predetermined signal in the downlink by using “mW” but not “dBm” of the true value.

Note that, more specifically, the path-loss estimating unit 14 is configured to estimate the propagation loss of each of the symbols constituting the predetermined signal in the downlink on the basis of the transmission power of each symbol constituting the predetermined signal stored in the transmission-power storing unit 13 in advance and the reception power of each symbol constituting the predetermined signal measured by the measuring unit 12.

The reference-signal reception-power calculating unit 15 is configured to calculate the reception power of the reference signal on the basis of the transmission power of the reference signal stored in the transmission-power storing unit 13 in advance and the propagation loss of the predetermined signal estimated by the path-loss estimating unit 14.

For example, the reference-signal reception-power calculating unit 15 is configured to calculate the reception power of the reference signal according to “Z (dBm)−path loss of predetermined signal (dBm)+k”. Here, “k” is a coefficient for correction.

The reference-signal reception-power calculating unit 15 is configured to calculate the reception power of a reference signal corresponding to each symbol on the basis of the transmission power of the symbol constituting the reference signal stored in the transmission-power storing unit 13 in advance and the propagation loss of the symbol constituting the predetermined signal estimated by the path-loss estimating unit 14.

### Operation of the Mobile Communication System according to the First Embodiment of the Present Invention

The operation of the mobile communication system according to the first embodiment of the present invention, more specifically, the operation of the mobile station UE according to the present embodiment for measuring the reception power of a reference signal in the downlink is described with reference to FIG. 4.

In Step S101, the mobile station UE measures the reception power Y (dBm) of a predetermined signal (for example, a P-SCH signal, an S-SCH signal or a P-BCH signal) transmitted by the radio base station eNB.

Specifically, the mobile station UE may measure the reception power Y (dBm) of the predetermined signal transmitted by the radio base station eNB, by performing the averaging process on multiple symbols constituting such predetermined signal.

In Step S102, the mobile station UE estimates the propagation loss (path loss) of the predetermined signal in the downlink on the basis of the transmission power X (dBm) of the predetermined signal stored in advance and the reception power Y (dBm) of the predetermined signal thus measured, that is, according to “X (dBm)−Y (dBm)”.

In Step S103, the mobile station UE calculates the reception power of the reference signal on the basis of the transmission power Z (dBm) of the reference signal stored in advance and the path loss of the predetermined signal thus estimated, that is, according to “Z (dBm)−Path Loss of Predetermined Signal (dBm)+k”.

### Operations and Effects of the Mobile Communication System According to the First Embodiment of the Present Invention

The mobile communication system according to the first embodiment of the present invention is configured to calculate the reception powers of symbols constituting a reference signal and being discontinuously transmitted in the frequency axis direction and the time axis direction on the basis of the reception power of a predetermined signal (for example, a P-SCH signal, an S-SCH signal or a P-BCH signal) continuously transmitted in the frequency axis direction or the time axis direction. This makes it possible to accurately measure the average reception quality of the reference signal.

Note that the above described operations of the radio base station eNB and the mobile station UE may be implemented by hardware, may be implemented by a software module executed by a processor, or may be implemented by a combination of both.

The software module may be provided in any type of storage medium such as an RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can read and write information from and to the storage medium. Also, the storage medium may be integrated into the processor. Also, the storage medium and the processor may be provided in an ASIC. The ASIC may be provided in the radio base station eNB and the mobile station UE. Also, the storage medium and the processor may be provided in the radio base station eNB and the mobile station UE as a discrete component.

Hereinabove, the present invention has been described in detail by use of the foregoing embodiment. It is obvious, however, to those skilled in the art that the present invention should not be limited to the embodiment described in this description. The present invention is implementable as modified and improved embodiments without departing from the sprit and the scope of the present invention defined by the description of the scope of the appended claims. Therefore, the explanation of this description is intended only to explain an illustrative example of the present invention, and is not intended to impose any limitation on the present invention.

1. A mobile station comprising:
a measuring unit configured to measure a reception power of a predetermined signal constituted of a symbol transmitted continuously in a frequency axis direction or in a time axis direction;
an estimating unit configured to estimate a propagation loss of the predetermined signal in a downlink on the basis of a transmission power of the predetermined signal and the reception power of the predetermined signal measured by the measuring unit, the transmission power of the predetermined signal being stored in advance; and
a calculating unit configured to calculate a reception power of a pilot signal on the basis of a transmission power of the pilot signal and the propagation loss of the predetermined signal estimated by the estimating unit, the transmission power of the pilot signal being stored in advance.

2. The mobile station according to claim 1, wherein
the measuring unit is configured to measure the reception power of the predetermined signal by performing an averaging process on reception powers of a plurality of the symbols transmitted continuously in the frequency axis direction or in the time axis direction.

3. A mobile communication method comprising the steps of:
measuring, at a reception apparatus, a reception power of a predetermined signal constituted of a symbol transmitted continuously in a frequency axis direction or in a time axis direction;
estimating, at the reception apparatus, a propagation loss of the predetermined signal in a downlink on the basis of a transmission power of the predetermined signal and the reception power of the predetermined signal thus measured, the transmission power of the predetermined signal being stored in advance; and
calculating a reception power of a pilot signal on the basis of a transmission power of the pilot signal and the propagation loss of the predetermined signal thus estimated, the transmission power of the pilot signal being stored in advance.
